(19) United States
(12) Patent Application Publication
(10) Pub. No.: US 2012/0280876 A1
(43) Pub. Date: Nov. 8, 2012

(54) Wireless equipment

(75) Inventor: Lanying Qu, Shenzhen (CN)

(73) Assignee: ZTE CORPORATION, Shenzhen, Guangdong (CN)

(21) Appl. No.: 13/520,358

(22) PCT Filed: Jul. 23, 2010
(86) PCT No.: PCT/CN10/75440

§ 371 Date: Jul. 3, 2012

(30) Foreign Application Priority Data
Mar. 23, 2010 (CN) 201010134226.2

(51) Int. Cl. H01Q 13/10

(52) U.S. Cl. 343/767

(57) ABSTRACT

The disclosure discloses a wireless device, includes a shell and a signal circuit board, wherein one or more loop-closed slot antennae are arranged on the shell; the slot antenna is provided with a feeding point and a grounding point; the feeding point and the grounding point are respectively connected with two ends of an slot antenna; and the feeding point is connected with the signal circuit board polarly. In the wireless device provided by the disclosure, one or more loop-closed slot antennae are arranged on the shell, and receiving and transmitting effects are achieved directly by utilizing a conductor slot on the shell, so that antenna in the shell can be saved; therefore, the space on a Printed Circuit Board (PCB) is saved and the wireless device is miniaturized.

### TECHNICAL FIELD

The disclosure belongs to the technical field of wireless device, in particular to wireless device provided with a slot antenna.

### BACKGROUND

Nowadays wireless communication technology is increasingly developed and popularized; for ordinary consumers, not only the performance of communication and Internet tool of the wireless communication device is concerned, but also the fashionable appearance is an important factor for the consumers to select products.

In a wireless device, an antenna plays a role in transmitting a radio frequency signal generated by a circuit board and transmitting a received radio frequency signal to the circuit board to realize wireless two-way transmission of audio signals, video signals, data and the like. An antenna is generally formed by a conductive material which forms a specific shape or opening a slot/slit with specific shape on the conductive material; and signal transmission is performed through appropriate feeding mode between the antenna and the circuit board, so that the radio frequency is transmitted and received effectively.

At present, most wireless device adopts a built-in antenna arranged in the device, and the size of the antenna is related to radio frequency, so the antenna must has a certain size and height to achieve enough radiation frequency to ensure effective transmission and reception of electromagnetic waves; therefore, the wireless device needs space large enough to accommodate the antenna therein, and other components of the wireless device are limited by the existence of the antenna. Because nowadays the layout and the structural design of Printed Circuit Board (PCB) become more and more difficult, and the space preserved for the antenna becomes smaller and smaller, how to reasonably select a position for placing the antenna to make the antenna meet the requirements on the layout and the structure of the PCB and antenna performance index becomes a problem.

### SUMMARY

The disclosure mainly aims to provide a wireless device with a slot antenna, which meets the requirements on the layout and the structure of the PCB and has a small volume.

The technical solution adopted by the disclosure may be that: the wireless device includes a shell and a signal circuit board which is arranged in the shell, wherein one or more loop-closed slot antennae are arranged on the shell; the slot antenna is provided with a feeding point and a grounding point; the feeding point and the grounding point are respectively connected with the two ends of an slot antenna; and the feeding point is connected with the signal circuit board polarly.

Preferably, the shell may be a metal shell; the slot antenna may be hollowed out on the outer surface of the shell; and an insulating material may be added between the slots of the slot antenna.

Preferably, the shell may be an insulation shell; and the slot antenna may be embedded into the inner surface or the outer surface of the shell.

Preferably, the slot antenna may be also provided with branched slot which is arranged inside or outside the slot antenna.

Preferably, capacitance or inductance component may be connected in series and/or in parallel between the slot antenna and the power output end of the signal circuit board.

Preferably, the slot antenna may be arranged on one or more surfaces of the shell.

Preferably, the feeding point of the slot antenna may be connected with the signal circuit board polarly through an elastic piece or a coaxial line.

Preferably, patterns of random graphics may be hollowed out, besides the area in which the slot antenna is positioned, on the shell.

Preferably, the track, on the shell, of the slot antenna may be one or a combination of S shape or straight line shape.

Preferably, the track, on the shell, of the branched slot may be one or a combination of multiple of straight line shape, S shape, ring shape and saw-tooth shape.

Compared with the prior art, in the wireless device provided by the disclosure, one or more loop-closed slot antennae are arranged on the shell, and receiving and transmitting effects are directly achieved by utilizing a conductor slot on the shell, so that an antenna in the shell can be saved; therefore, the space on PCB is saved and the wireless device is miniaturized.

### BRIEF DESCRIPTION OF THE DRAWINGS

FIG. 1 shows a structural diagram of a wireless device with a slot antenna provided by the embodiment of the disclosure; and

FIG. 2 shows an echo loss curve diagram debugged by a slot antenna provided by the embodiment of the disclosure on a wireless network card.

### DETAILED DESCRIPTION

The disclosure is described below with reference to the accompanying drawings and embodiments in detail.

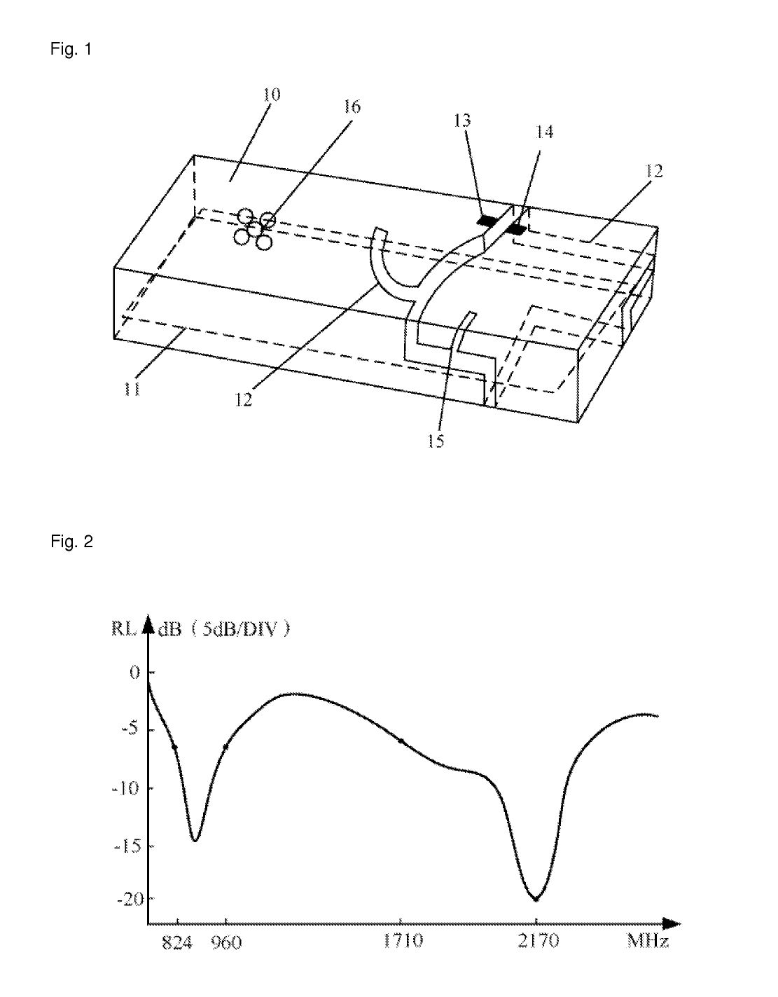

As shown in FIG. 1, FIG. 1 shows the structural diagram of a wireless device with a slot antenna provided by the embodiment of the disclosure. In the embodiment, the wireless device includes a shell 10, a signal circuit board 11, and one or more loop-closed slot antennae 12 arranged on the shell 10, wherein each slot antenna 12 includes a feeding point 13 and a grounding point 14; the feeding point 13 and the grounding point 14 are respectively connected with two ends of an slot antenna 12; the is positions of the feeding point 13 and the grounding point 14 can be exchanged; the positions on the signal circuit board 11 also can be adjusted as required; the feeding point 13 can be connected with the signal circuit board 11 polarly through a elastic piece or a coaxial line or other connection mode; components such as a capacitor or an inductor are connected in series and/or in parallel between the power output end of the signal circuit board 11 and the slot antenna 12, so that not only the harmonic frequency of the antenna can be adjusted to optimize a bandwidth, but also a mainboard can be effectively prevented from being damaged by static electricity.

According to the difference of the required frequency bands of the antenna, the loop perimeter of the slot antenna 12 can be adjusted properly, and the bandwidth and the depth of the echo loss of the slot antenna 12 can be adjusted by adjusting the width and the length of the slot; and generally, the most commonly used width is 1-2 mm.

The shell 10 of the wireless device can be an individual full-metal shell; the slot antenna is hollowed out in the outer surface of the shell 10; and an insulating material is added between the slots. The shell 10 of the wireless device also can be an insulating material shell; and the slot antenna is embedded in or out of the plastic or other insulating material shell.

Further, the slot antenna 12 is also provided with a plurality of branched slots 15, wherein the branched slots 15 are arranged inside or outside the slot antenna 12. The branched slots 15 are mainly configured to increasing high and low frequency bandwidth.

In the embodiment, the track, on the shell 10, of the slot antenna 12 can be set as one or the combination of S shape and straight line shape; due to the setting, a best position on the wireless device can be selected when the slot antenna 12 is debugged so as to achieve better antenna performance; and simultaneously the directivity of the slot antenna 12 can be changed by adjusting the direction and the width of the slot of the slot antenna 12, so as to fulfill the aim of reducing Specific Absorption Rate (SAP) and meet lo the requirement of market. If the antenna has a plurality of frequency bands, the bandwidth can be adjusted by increasing the branched slots 15; and the track, on the shell 10, of the branched slots 15 is one or the combination of multiple of S shape, straight line shape, ring shape, saw-tooth shape, and can be distributed inside the slot antenna 12 and also can be distributed outside the slot antenna 12. Specific is distribution, and the length, the width and the number of the slot can be determined according to the requirement on the debugging of the slot antenna.

Further, the slot antenna 12 can be arranged on one surface of the wireless device, and also can be arranged on a plurality of surfaces of the wireless device. As shown in FIG. 1, the slot antenna is distributed on five surfaces of the wireless device, and the specific distribution is determined according to actual debugging and the frequency bands of the antennae. Conductors on the upper and lower surfaces of the slot antenna 12 on the shell 10 can be connected directly, and also can be connected in the modes, such as conductive foam or elastic piece and the like, which can conduct the slot antenna 12; and specific connection mode should be determined according to the structure of an actual product.

In order to make the appearance of the wireless device more three-dimensional and beautiful, as shown in FIG. 1, the wireless device is also provided with random hollow pattern 16 besides the area in which the slot antenna 12 is positioned; the hollow pattern 16 does not influence the performance of the antenna and meets the personalized experience of users.

At present, the main frequency bands on a mobile phone and a network card are 824 MHz-960 MHz and 1710 MHz-2170 MHz. FIG. 2 shows the echo loss curve diagram debugged by a slot antenna provided by the embodiment of the disclosure on a wireless network card, it can be seen that the bandwidth fully meets the requirements of a 5-frequency antenna. Definitely, the working range of an antenna form includes but is not limited to 824 MHz-2170 MHz. According to different antenna application occasions, the frequency bands of the antenna are different, which can be realized by adjusting the length and the width of the slot antenna 12.

In the disclosure, a slot antenna technology is applied to the shell of the wireless device, the signal circuit board and a conductive material-containing shell are connected together through a metal elastic piece, a coaxial line and the like, and the transmitting and receiving effects are achieved directly by utilizing a conductor slot on the shell, so that the antenna in the shell can be saved and the space on the PCB can be saved; therefore, the wireless device can be miniaturized. In the embodiment of the disclosure, taking the wireless network card as a basis, a new annular slot antenna form is summarized based on the conventional antenna technology by combining actual debugging, and various disadvantages that the conventional slot antenna has narrow is bandwidth, large area, and is mainly used for high frequency and the like on a low frequency are overcome. The slot antenna mainly uses one or more loop-closed annular slots to form low-frequency and high-frequency radiation loop, and is realized by optimizing the high frequency by the branched slots. Further, components, such as capacitor, inductor and the like can be connected in series and/or in parallel close to the power output port of the signal circuit board, so that not only the bandwidth and the harmonic frequency of the antenna can be debugged, but also the signal circuit board can be effectively prevented from being damaged by the static electricity.

It should be noted that the wireless device of the disclosure includes but is not limited to mobile phone and network card, and also can be applied to the occasions, such as wireless router and the like, where the antenna technology can be applied.

The above is further detailed description of the disclosure by combining specific preferred embodiments, but the specific embodiment of the disclosure is not intended to limit the description. For ordinary technical personnel of the technical field belonging to the disclosure, a plurality of single deductions or replacements which can be made on the premise of not separating from the conception of the disclosure shall fall within the scope of protection of the disclosure.

What is claimed is:

1. A wireless device comprising a shell and a signal circuit board arranged in the shell, wherein one or more loop-closed slot antennae are arranged on the shell, the slot antenna is provided with a feeding point and a grounding point, the feeding point and the grounding point are respectively connected with two ends of the slot antenna, and the feeding point has a polar connection with the signal circuit board.

2. The wireless device according to claim 1, wherein the shell is a metal shell; the slot antenna is hollowed out on an outer surface of the shell; and an insulating material is added between slots of the slot antenna.

3. The wireless device according to claim 1, wherein the shell is an insulation shell, and the slot antenna is embedded into an inner surface or an outer surface of the shell.

4. The wireless device according to claim 1, wherein the slot antenna is further provided with a branched slot which is arranged inside or outside the slot antenna.

5. The wireless device according to claim 1, wherein capacitance or inductance components are connected in series and/or in parallel between the slot antenna and a power output end of the signal circuit board.

6. The wireless device according to claim 2, wherein the slot antenna is arranged on one or a plurality of surfaces of the shell.

7. The wireless device according to claim 1, wherein the feeding point of the slot antenna has the polar connection with the signal circuit board through any one of an elastic piece, a coaxial line and an antenna pin.

8. The wireless device according to claim 2, wherein the shell is hollowed out a pattern of any design in an area other than an area where the slot antenna is positioned.

9. The wireless device according to claim 1, wherein the slot antenna has a track on the shell, and the track is one or a combination of an S shape and a straight line shape.

10. The wireless device according to claim 4, wherein the branched slot has a tack on the shell, and the track is one or several combinations of a straight line shape, or an S shape, or a ring shape or a saw-tooth shape.

11. The wireless device according to claim 3, wherein the slot antenna is arranged on one or a plurality of surfaces of the shell.

12. The wireless device according to claim 3, wherein the shell is hollowed out a pattern of any design in an area other than an area where the slot antenna is positioned.

13. The wireless device according to claim 2, wherein the slot antenna has a track on the shell, and the track is one or a combination of an S shape and a straight line shape.

14. The wireless device according to claim 3, wherein the slot antenna has a track on the shell, and the track is one or a combination of an S shape and a straight line shape.

15. The wireless device according to claim 4, wherein the slot antenna has a track on the shell, and the track is one or a combination of an S shape and a straight line shape.

16. The wireless device according to claim 5, wherein the slot antenna has a track on the shell, and the track is one or a combination of an S shape and a straight line shape.
